(19) United States
(12) Patent Application Publication
(10) Pub. No.: US 2023/0325091 A1
(43) Pub. Date: Oct. 12, 2023

(54) DEVICES AND METHODS FOR SYNCHRONOUS AND ASYNCHRONOUS INTERFACE USING A CIRCULAR FIFO

(71) Applicant: Chronos Tech LLC, San Diego, CA (US)

(72) Inventors: Stefano Giaconi, San Diego, CA (US); Giacomo Rinaldi, San Diego, CA (US); Matheus Gibiluka, San Diego, CA (US); David Fong, San Diego, CA (US)

(21) Appl. No.: 18/106,475

(22) Filed: Feb. 6, 2023

Related U.S. Application Data
(60) Provisional application No. 63/306,811, filed on Feb. 4, 2022.

(51) Int. Cl. G06F 3/06

(52) U.S. Cl. CPC G06F 3/0613; G06F 3/0659; G06F 3/0673; G06F 3/0656

(57) ABSTRACT

A circular First-In-First-Out (FIFO) Buffer is provided as an intuitive interface between synchronous domains and asynchronous domains by incorporating flow control and standard synchronizers to allow for serialization and deserialization that can be carried out as an asynchronous-to-synchronous transition, a synchronous-to-asynchronous transition, or even a fully asynchronous circular transition. Each of these configurations may also include single read or multiple-read operations.

### RELATED APPLICATIONS INFORMATION

This present application claims the benefit of priority under 35 U.S.C. 119(e) to Provisional Patent Application Ser. No. 63/306,811, filed Feb. 4, 2022, the content of which is incorporated herein in its entirety.

### BACKGROUND

### 1. Technical Field

The various embodiments described herein are related to application specific integrated circuits (ASICs), and more particularly to the design of First In First Out (FIFO) buffers used in various ASICs.

### 2. Related Art

Continuing advances in semiconductor device fabrication technology have yielded a steady decline in the size of process nodes. For example, 7 nanometer (nm) process nodes were introduced in 2017 but were quickly succeeded by 5 nm fin-field-effect-transistors (FinFETs) in 2018, while 3 nm gate-all-around-field-effect-transistor (GAAFET) process nodes are projected for commercialization by end of 2022.

The decrease in process node size allows a growing number of intellectual property (IP) cores or IP blocks to be placed on a single ASIC chip. The latest ASIC designs often use a comparatively large silicon die and include combinations of independent IP blocks and logic functions. At the same time, modern applications also require increased connectivity and large data transfers between various IP blocks. The vast majority of modern ASIC chips are heterogenous systems to enable optimization of performance and power figures for the numerous IPs, as well as multi-core implementations, leading to a very complicated interconnect sub-system. Therefore, a Globally Asynchronous Locally Synchronous (GALS) interconnect approach is gaining traction in the industry.

All indications point to even higher levels of integration and data processing in further System on Chips (SoCs) in the year to come. This will allow even more functions to be added, making systems more complex, more intelligent, and more power efficient while putting even more pressure on the interconnect fabric.

Modern SoCs for Artificial Intelligence (AI) and Machine Learning (ML) require high throughout and most importantly low latency architectures. Data must move between GPUs, TMUs or CPUs and the memory system with minimum latency, because most of the operations use a very large amount of data and repeated linear matrices operations.

Asynchronous interconnect topologies have shown the advantage of very low latency operation across long distances, as they do not require a clock distribution to operate and tolerate on-chip variation and cross-voltage domains, resulting in the ideal fabric for heterogeneous manycore architectures such as AI accelerators and/or cloud computing. The majority of modern SoCs are heterogeneous systems composed by many diverse IPs. To better optimize power, performance and area (PPA), some of the IPs can be implemented as synchronous designs while some other can be asynchronous designs. The Network on Chip (NOC) is a good example of a possible asynchronous IP.

What is needed is a way to leverage existing synchronous computing solutions and at the same time take advantage of new asynchronous fabrics.

### SUMMARY

Devices and methods for Application-Specific Integrated Circuit (ASIC) design are provided, including a modular First In First Out (FIFO) Buffer configured as an interface between synchronous domains and asynchronous domains by incorporating flow control and standard synchronizers to allow for serialization and deserialization within the asynchronous domain enabling area saving. The FIFO interface may be configured as an asynchronous to synchronous transition, a synchronous to asynchronous transition, or even a fully asynchronous circular transition, and each of these configurations may include single read or multiple-read operations.

The FIFO interface provides an intuitive, reliable interface among the two domains which allows for easy transition and decoupling, back pressure control, use of existing standard synchronizers, and serialization or deserialization within the asynchronous domain, enabling area saving.

In one embodiment, a First In First Out (FIFO) Buffer comprises: a synchronous write section including a synchronous controller and synchronous data path, wherein the synchronous write section receives data from a synchronous domain; and an asynchronous read section including an asynchronous controller and an asynchronous data path, wherein the asynchronous read section communicates with the synchronous write section to provide the data from the synchronous domain to an asynchronous domain.

In another embodiment, a FIFO buffer comprises: an asynchronous write section which receives data from an asynchronous domain; a synchronous read section which communicates with the asynchronous write section to provide the data from the asynchronous domain to a synchronous domain.

In a further embodiment, a method of fabricating a FIFO comprises: forming a synchronous write area; forming an asynchronous read area; and creating a flow control pathway between the synchronous and asynchronous areas;

In a further embodiment, a method of transitioning data in a First In First Out (FIFO) Buffer comprises the steps of: receive synchronous data at a synchronous data controller; perform a flow control check via the synchronous data controller; store synchronous data to a synchronous data path; performing a flow control check via the asynchronous data controller; and transmit data from an asynchronous data path to an asynchronous domain.

Other features and advantages of the present inventive concept should be apparent from the following description which illustrates by way of example aspects of the present inventive concept.

### BRIEF DESCRIPTION OF THE DRAWINGS

The above and other aspects and features of the present inventive concept will be more apparent by describing example embodiments with reference to the accompanying drawings, in which:

FIG. 1 is a general block diagram illustrating a possible embodiment of a generic Synchronous to Asynchronous Circular First In First Out (FIFO) with serialization and flow-control, according to one embodiment of the invention;

FIG. 2 is a general block diagram of a possible embodiment of the Synchronous to Asynchronous FIFO controller, according to one embodiment of the invention;

FIG. 3 is a general block diagram illustrating a possible embodiment of a generic Asynchronous to Synchronous Circular FIFO with deserialization and flow-control, according to one embodiment of the invention;

FIG. 4 is a general block diagram of a possible embodiment of the Asynchronous to Synchronous FIFO controller, according to one embodiment of the invention;

FIG. 5 is a general block diagram illustrating a possible embodiment of a generic Multi-Read Synchronous to Asynchronous Circular FIFO with serialization and flow-control, according to one embodiment of the invention;

FIG. 6 is a general block diagram illustrating a possible embodiment of a generic Multi-Read Asynchronous to Synchronous Circular FIFO with deserialization and flow-control, according to one embodiment of the invention;

FIG. 7 is a general block diagram illustrating a possible embodiment of a generic Asynchronous Circular FIFO with deserialization and flow-control, according to one embodiment of the invention;

FIG. 8 is a general block diagram illustrating a possible embodiment of a generic Multi-Read Asynchronous Circular FIFO with deserialization and flow-control, according to one embodiment of the invention;

FIG. 9 is a block diagram illustrating a method of transitioning data using the Circular FIFO, according to one embodiment of the invention; and

FIG. 10 is a block diagram that illustrates a computer-embodied system, according to various embodiments.

### DETAILED DESCRIPTION

Embodiments described herein provide devices and methods for Application-Specific Integrated Circuit (ASIC) design, including a modular First In First Out (FIFO) Buffer configured as an interface between synchronous domains and asynchronous domains by incorporating flow control and standard synchronizers to allow for serialization and deserialization within the asynchronous domain enabling area saving. The FIFO interface may be configured as an asynchronous to synchronous transition, a synchronous to asynchronous transition, or even a fully asynchronous circular transition, and each of these configurations may include single read or multiple-read operations.

This invention describes both a Synchronous to Asynchronous Circular FIFO as well as an Asynchronous to Synchronous Circular FIFO, which enable an easy and effective way of transitioning between synchronous and asynchronous domains. The FIFOs can be used as interfaces within Globally Asynchronous Locally Synchronous (GALS) systems, or as building blocks for more complex Intellectual Properties (IPs) such as Switch, Network on Chip (NoC) or Crypto Core, allowing System on Chip (SoC) architects the freedom to mix and match synchronous and asynchronous domains in order to optimize Power, Performance and Area (PPA) metrics at the SoC level.

While certain embodiments are described, these embodiments are presented by way of example only, and are not intended to limit the scope of protection. The methods and systems described herein may be embodied in a variety of other forms. Furthermore, various omissions, substitutions, and changes in the form of the example methods and systems described herein may be made without departing from the scope of protection.

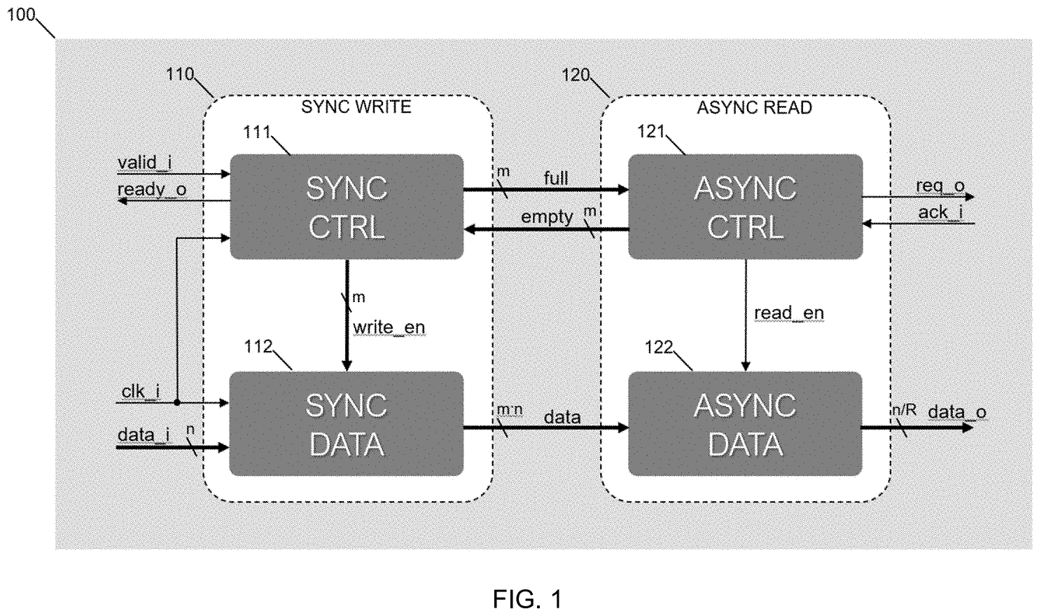

FIG. 1 is a block diagram illustrating one embodiment of a circular FIFO (100) configured as a buffer from a synchronous to an asynchronous domain. The FIFO is divided into two sections: a Synchronous Write section (110) and an Asynchronous Read section (120).

The Synchronous Write section (110) allows incoming synchronous data to be written into a set of memory elements following a flow control step (which can be Valid/Ready or Credit Based). This Synchronous Write section (110) is divided into a Synchronous Controller (111) which takes care of the control signals in the synchronous domain, as well as the synchronizers; and a Synchronous Data path (112) with the memory element (usually flip flops or latches) in the synchronous domain.

The Asynchronous Read section (120) allows a generic asynchronous interface, either Bundled Data (BD) or Quasi Delay Insensitive (QDI), to read the data in accordance with the flow control rules. This Asynchronous Read section (120) includes an Asynchronous Controller (121) which produces the asynchronous control signals and an Asynchronous Data path (122) which provides the asynchronous data in the correct encoding scheme for the specified asynchronous template (i.e., BD or QDI).

The FIFO (100) is configurable and allows for any data bus width (n) and any FIFO depth (m). This FIFO (100) also allows serialization of the data in the asynchronous domain without the need of high-speed clocks.

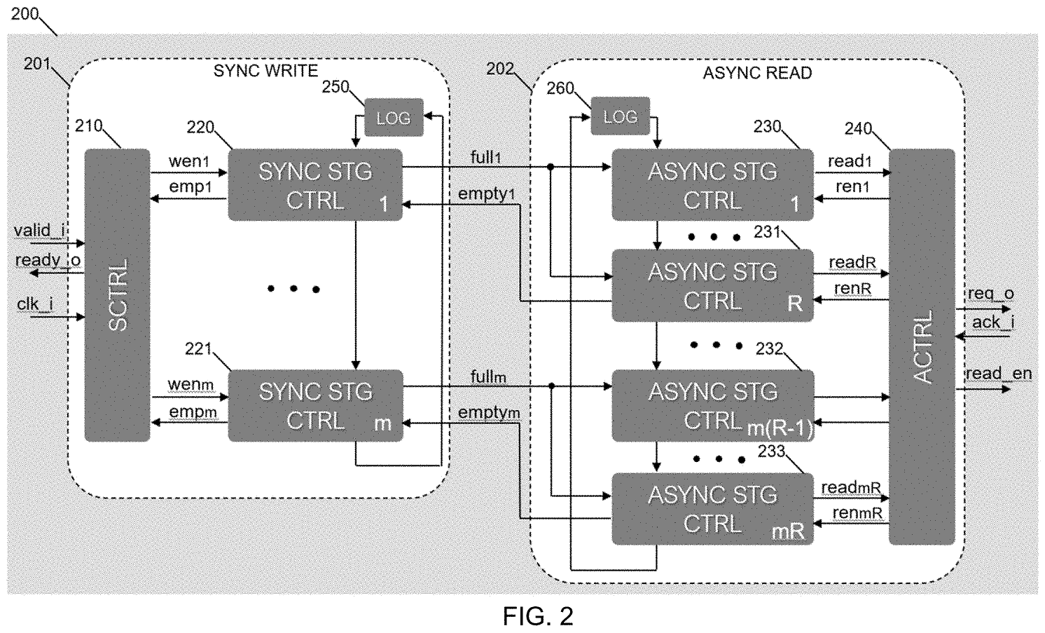

FIG. 2 is a block diagram illustration of one embodiment of the Synchronous Controller from the Synchronous to Asynchronous FIFO (100) illustrated in FIG. 1. The Synchronous Controller (200) is divided into a Synchronous Write Controller (201) and an Asynchronous Read Controller (202). The Synchronous Write Controller (201) is built in a modular way and uses an SController (210) to manage the flow-control signal and at least one or more (i.e. 1 to “m”) Synchronous Stage Controllers (220-221)—one for each FIFO depth stage. The Synchronous Stage controllers (220-221) are enabled one at a time using cascaded stages and some logic (250).

One possible implementation can be a Twisted Ring Counter configuration. In this implementation, each of the Synchronous Stage Controllers (220-221) produces a “full” signal and receives an Asynchronous “empty” signal from the Asynchronous Read Controller (202) that gets synchronized and used by the Synchronous Stage Controllers. The Asynchronous Read Controller (202) is also modular and may contain an AController (240) which takes care of reconciling the asynchronous protocol and the serialization, and at least one or more (i.e. 1 to “mR”) Asynchronous Stage Controllers (230-233), where m is the FIFO depth and R is the Serialization Ratio. Also, in this case, only one of the Asynchronous Stage Controllers is selected for a read operation at each time by cascading the stages and using some logic (260).

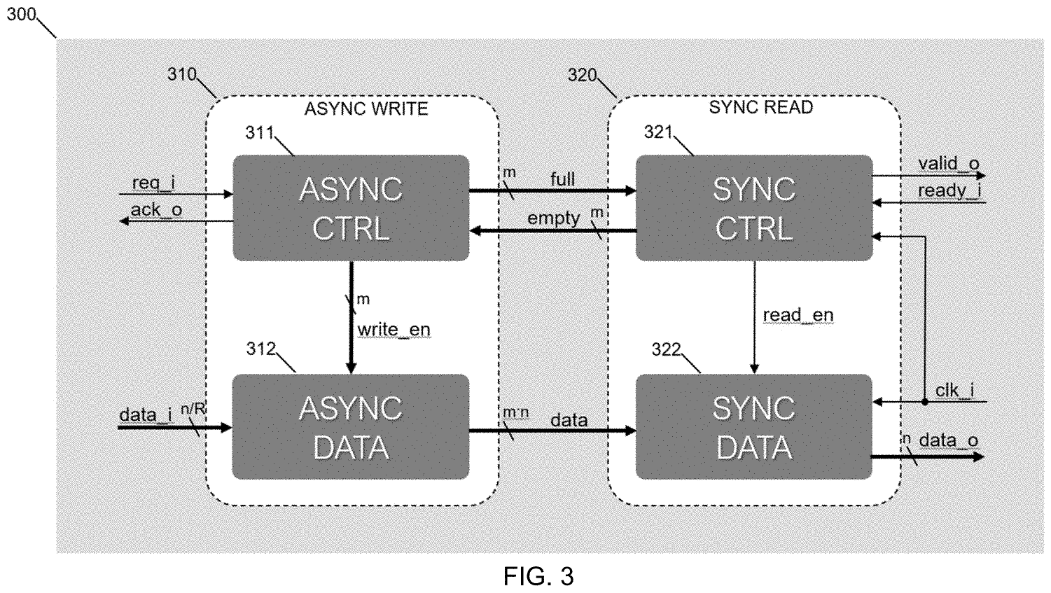

FIG. 3 is a block diagram illustration of one embodiment of a circular FIFO (300) configured as a buffer from an asynchronous to a synchronous domain. This FIFO (300) is divided in two sections: an Asynchronous Write section (310) and a Synchronous Read section (320).

The Asynchronous Write section (310) allows a generic asynchronous interface, either BD or QDI, to write the incoming asynchronous data into a set of memory elements. This Asynchronous Write section (310) is divided into an Asynchronous Controller (311) which takes care of the control signals in the asynchronous domain; and an Asynchronous Data path (312) with the memory elements in the Asynchronous domain.

The Synchronous Read section (320) allows a synchronous flow control interface (either Valid/Ready or Credit Based) to read the data in accordance with the flow control rules. This Synchronous Read section (320) is further divided into the Synchronous Controller (321), which produces the synchronous control signals, and the Synchronous Data path (322) to deliver data.

The FIFO (300) is configurable and allows for any data bus width (n) and any FIFO depth (m). This FIFO (300) also allows deserialization of the data in the asynchronous domain without the need of high-speed clocks.

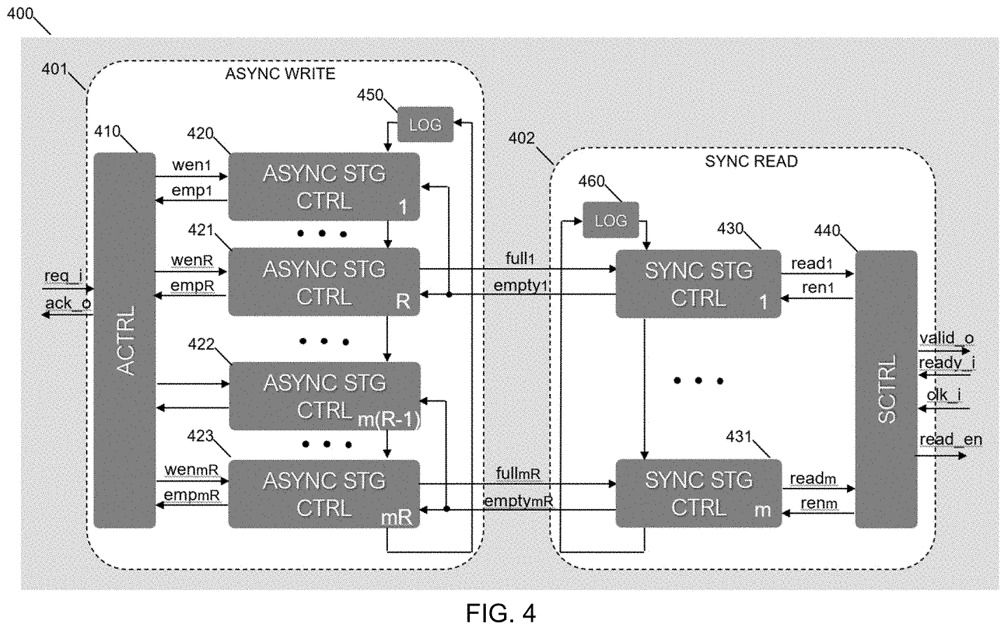

FIG. 4 is a block diagram illustrating one embodiment of the Asynchronous Controller from the Asynchronous to Synchronous FIFO (300) from FIG. 3. The Asynchronous Controller (401) is divided into an Asynchronous Write Controller (401) and a Synchronous Read Controller (402). The Asynchronous Write Controller (401) is built in a modular way and uses an AController (410) to manage the asynchronous protocol signal and at least one or more (i.e., 1 to “mR”) Asynchronous Stage Controllers (420-423), where “m” is the FIFO depth, and “R” is the Deserialization Ratio. The Asynchronous Stage Controllers (420-423) are enabled one at the time using cascaded stages and some logic (450).

One possible implementation can be a Twisted Ring Counter configuration. The Synchronous Read Controller (402) is also modular and may contain an SController (440) which takes care of flow-control and at least one or more (i.e. 1 to “m”) Synchronous Stage Controllers (430-431), where m is the FIFO depth. Each Synchronous Stage Controller (430-431) receives an asynchronous “full” signal that gets synchronized and used by the Synchronous Stage Controllers, and generate a synchronous “empty” signal to the Asynchronous write controller. Also, in this case, only one of the Synchronous Stage Controllers (430-431) is selected for a read operation at each time by cascading the stages and using some logic (460).

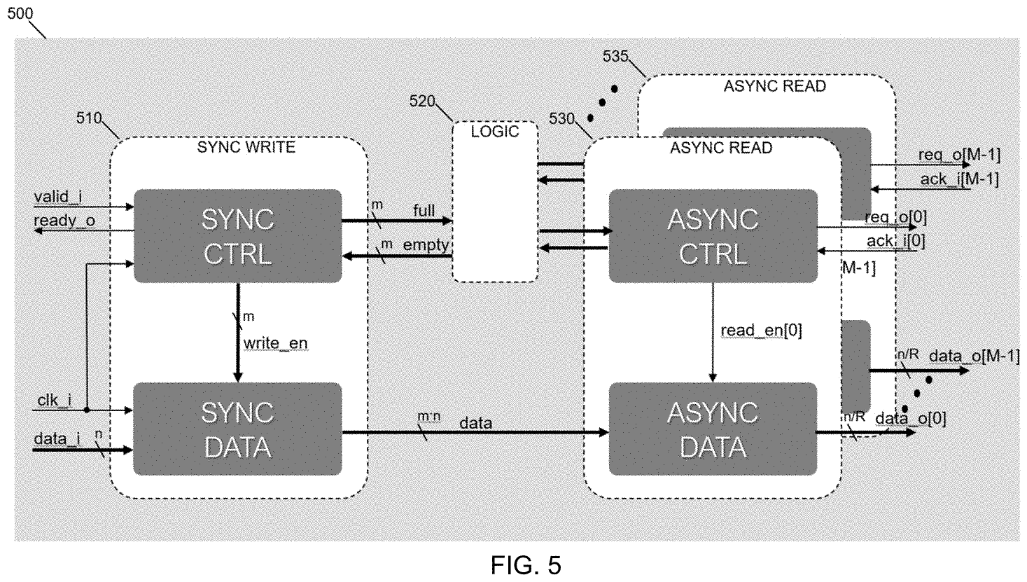

FIG. 5 is a block diagram illustration of one embodiment of a Multi-Read Synchronous to Asynchronous circular FIFO (500) configured as a multi-read buffer from a synchronous to an asynchronous domain. This multi-read FIFO (500) allows a single synchronized writing of data into a memory, and multiple (M) simultaneous asynchronous data reads. It is divided into three sections: a Synchronous Write section (510), multiple Asynchronous Read sections (530-535), and a Logic section (520).

The Synchronous Write section (510) which allows the incoming synchronous data to be written into a set of memory elements following a flow control (it can be Valid/Ready or Credit Based). This Synchronous Write section (510) may be identical to the Synchronous Write section (110) in FIG. 1, with the memory element in the synchronous domain.

The multiple (M) Asynchronous Read sections (530-535) allow a generic asynchronous interface, either Bundled Data (BD) or Quasi Delay Insensitive (QDI), to read the data in accordance with the flow control rules. Each of these Asynchronous Read sections (530-535) can be identical to the Asynchronous Read section (120) in FIG. 1.

The Logic section (520) reconciles the multiple (M) full and empty signals coming from the individual Asynchronous Read sections (530-535) to a single set of full and valid signals for the Synchronous Write section (510).

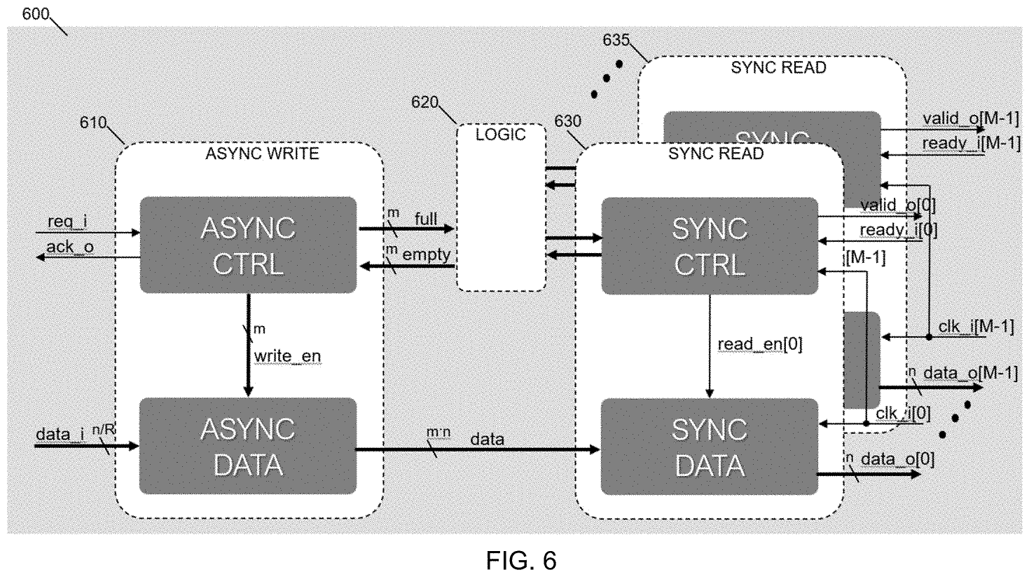

FIG. 6 is a block diagram illustrating one embodiment of a Multi-Read Asynchronous to Synchronous circular FIFO (600). This multi-read FIFO (600) allows a single asynchronous writing of data into a memory, and multiple (M) simultaneous clocked data reads. It is divided into three sections: a Asynchronous Write section (610), a multiple (M) Synchronous Read sections (630-635), and a Logic section (620).

The Asynchronous Write section (610) allows a generic asynchronous interface, either BD or QDI, to write the incoming asynchronous data into a set of memory elements. This Asynchronous Write section (610) can be identical to the Asynchronous Write section (310) in FIG. 3, with the memory element in the synchronous domain.

The multiple (M) Synchronous Read sections (630-635) allow a synchronous flow control interface (either Valid/Ready or Credit Based) to read the data in accordance with the flow control rules. Each of these Synchronous Read sections (630-635) can be identical to the Synchronous Read sections (320) in FIG. 3.

The Logic section (620) reconciles the multiple (M) full and empty signals coming from the individual Synchronous Read sections (630-635) into a single set of full and valid signals for the Asynchronous Write section (610).

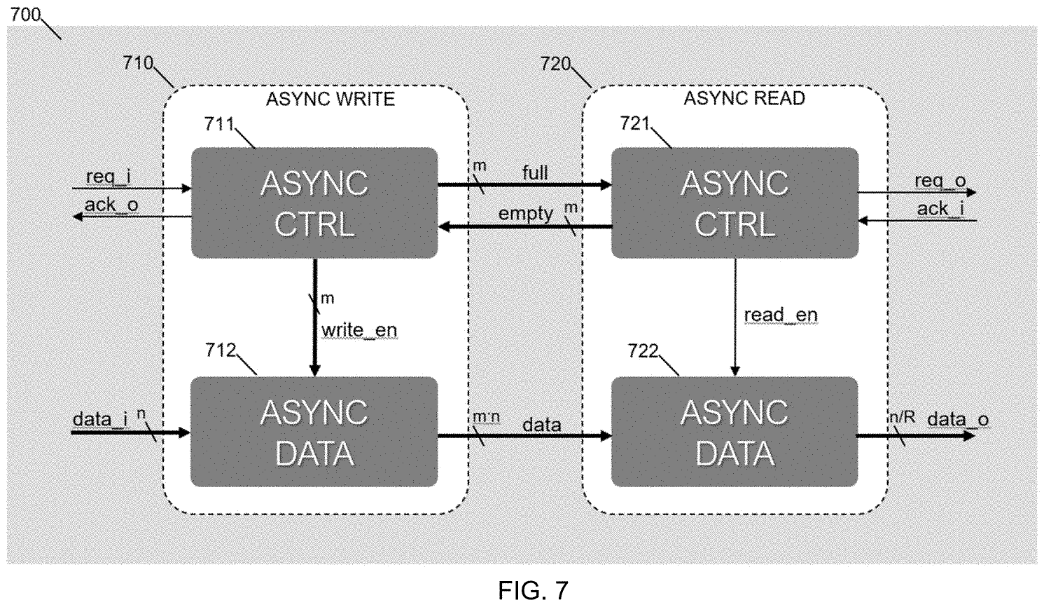

FIG. 7 is a block diagram illustration of one embodiment of an Asynchronous circular FIFO (700). In this embodiment, the FIFO (700) is divided in two sections: an Asynchronous Write section (710) and an Asynchronous Read section (720).

The Asynchronous Write section (710) allows a generic asynchronous interface, either BD or QDI, to write the incoming asynchronous data into a set of memory elements. This Asynchronous Write section (710) is divided into an Asynchronous Controller (711) which takes care of the control signals in the asynchronous domain, and an Asynchronous Data path (712) with the memory elements in the Asynchronous domain.

The Asynchronous Read section (720) allows a generic asynchronous interface, either Bundled Data (BD) or Quasi Delay Insensitive (QDI), to read the data respecting the flow control. This Asynchronous Read section (720) is divided into an Asynchronous Controller (721) which produces the asynchronous control signals, and the Asynchronous Data path (722).

The Asynchronous circular FIFO (700) is configurable and allows for any data bus width (n) and any FIFO depth (m), it also allows serialization or deserialization of the data domain without the need of high-speed clocks. It can be used to translate signaling from one asynchronous template (i.e. BD) to another (i.e. QDI).

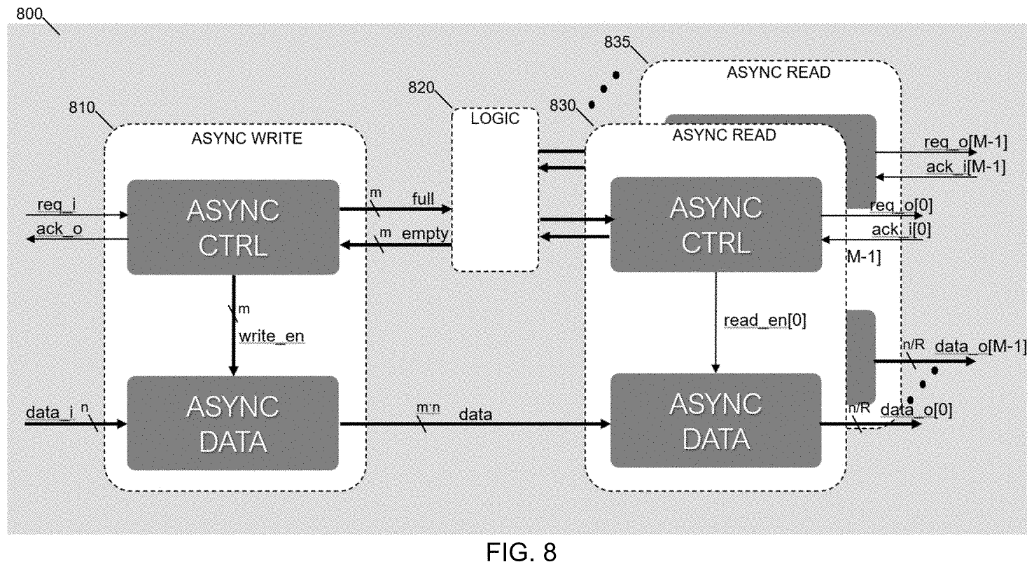

FIG. 8 is a block diagram illustration of a Multi-Read Asynchronous circular FIFO (800). This FIFO (800) allows a single writing of data into a memory, and multiple (M) simultaneous data reads. It is divided in three sections: the Asynchronous Write section (810), the multiples (M) Asynchronous Read sections (830-835), and the Logic section (820).

The Asynchronous Write section (810) allows a generic asynchronous interface, either BD or QDI, to write the incoming asynchronous data in a set of memory elements. This section can be identical to the Asynchronous Write section (310) in FIG. 3 with the memory element in the asynchronous domain.

The multiple (M) Asynchronous Read sections (830-835) allow a generic asynchronous interface, either Bundled Data (BD) or Quasi Delay Insensitive (QDI), to read the data in accordance with the flow control rules; each of those sections can be identical to the Asynchronous Read section (120) in FIG. 1.

The Logic section (820) reconciles the multiple (M) full and empty signals coming from the individual Read sections into a single set of full and valid signals for the Write section.

This implementation can be used also as a signaling translator between two different asynchronous templates.

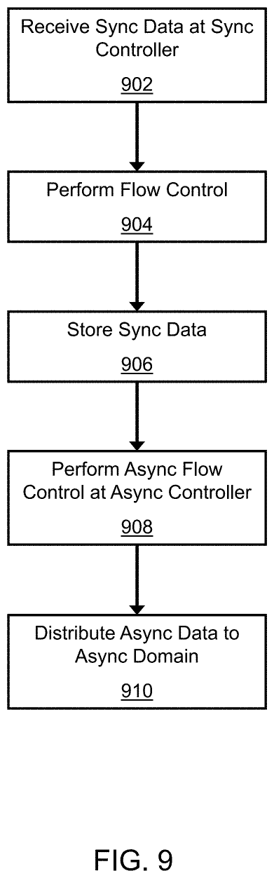

FIG. 9 illustrates one embodiment of a method of transitioning data between synchronous and asynchronous domains using the FIFO, comprising the steps of receiving data from the synchronous domain at the Synchronous Controller (step 902), performing a flow control check of the synchronous data (step 904), writing the synchronous data to the Synchronous Data Path (step 906), performing an asynchronous flow control check via the Asynchronous Controller (step 908), and then distributing the asynchronous data to the asynchronous domain via the Asynchronous Data Path (step 910).

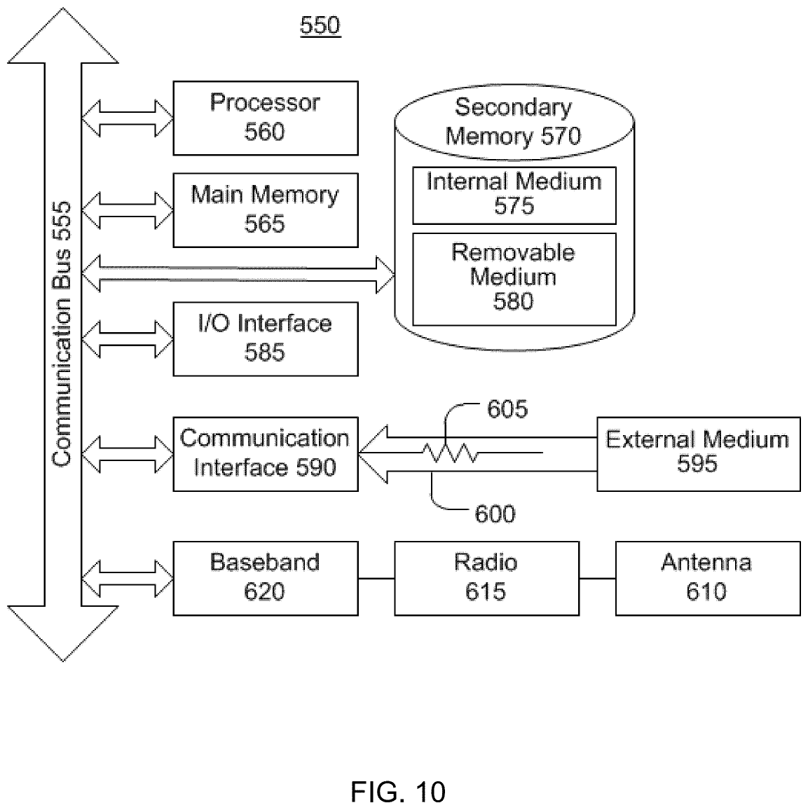

FIG. 10 is a block diagram illustrating a wired or wireless system 550 according to various embodiments. Referring to FIGS. 1 and 8, the system 550 may be used to implement the FIFO.

In various embodiments, the system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPM”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, the secondary memory 570 may include other similar means for allowing computer programs or other data or instructions to be loaded into the system 550. Such means may include, for example, an external storage medium 595 and a communication interface 590. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are the removable medium 580 and a communication interface, which allow software and data to be transferred from an external storage medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. The electrical communication signals 605 are preferably provided to communication interface 590 via a communication channel 600. In one embodiment, the communication channel 600 may be a wired or wireless network, or any variety of other communication links. Communication channel 600 carries the electrical communication signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The processor 560 has access to one or more data storage areas including, for example, but not limited to, the main memory 565 and the secondary memory 570. The processor 560 is preferably configured to execute instructions (i.e., computer programs or software) that can be stored in the main memory 565 or in the secondary memory 570. Computer programs can also be received from the baseband processor 610 and stored in the main memory 565 or in the secondary memory 570, or executed upon receipt. Such computer programs, when executed, enable the system 550 to perform the various functions of the present invention as previously described. For example, the main memory 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A First In First Out Buffer (FIFO), comprising:
a synchronous write section which receives synchronous data from a synchronous domain;
an asynchronous read section which communicates with the synchronous write section to provide the data from the synchronous domain to an asynchronous domain.

2. The FIFO of claim 1, further comprising a synchronous controller which performs a synchronous flow control operation prior to receiving synchronous data.

3. The FIFO of claim 2, further comprising a synchronous data path which stores the synchronous data from the synchronous domain after the flow control operation.

4. The FIFO of claim 1, further comprising an asynchronous controller which performs an asynchronous flow control operation prior to receiving synchronous data from the synchronous write section.

5. The FIFO of claim 4, further comprising an asynchronous data path which receives the synchronous data from the synchronous data path and distributes corresponding asynchronous data to the asynchronous domain.

6. The FIFO of claim 1, further comprising an asynchronous multi-read section which allows a single writing of synchronous data into a memory with multiple (M) simultaneous asynchronous data reads therefrom.

7. A First In First Out Buffer (FIFO), comprising:
an asynchronous write section which receives data from an asynchronous domain;
a synchronous read section which communicates with the asynchronous write section to provide the data from the asynchronous domain to a synchronous domain.

8. The FIFO of claim 7, further comprising an asynchronous controller which performs an asynchronous flow control operation prior to receiving the asynchronous data.

9. The FIFO of claim 8, further comprising an asynchronous data path which stores the asynchronous data from the asynchronous domain after the flow control operation.

10. The FIFO of claim 7, further comprising a synchronous controller which performs a synchronous flow control operation prior to receiving synchronous data from the synchronous write section.

11. The FIFO of claim 10, further comprising a synchronous data path which receives the synchronous data from the asynchronous data path and distributes corresponding synchronous data to the synchronous domain.

12. The FIFO of claim 7, further comprising a synchronous multi-read section which allows a single writing of asynchronous data into a memory with multiple (M) simultaneous asynchronous data reads therefrom.

13. The FIFO of claim 7, where the synchronous read section is instead configured as an asynchronous read section to convert one type of asynchronous data into another type of asynchronous data.

14. A method for fabricating a First In First Out (FIFO) Buffer, comprising the steps of:
forming a synchronous write area;
forming an asynchronous read area; and
creating a flow control pathway between the synchronous and asynchronous areas.

15. The method of claim 14, further comprising forming a synchronous controller within the synchronous write area for performing a flow control step with synchronous data received from a synchronous domain.

16. The method of claim 15, further comprising forming a synchronous data path in the synchronous write area for writing synchronous data which passes the flow control step.

17. The method of claim 16, further comprising forming an asynchronous controller within the asynchronous read area for performing a flow control step with the synchronous controller in the synchronous write area.

18. The method of claim 17, further comprising forming an synchronous data path in the asynchronous read area for reading synchronous data which passes the flow control step between the synchronous controller and the asynchronous controller.

19. The method of claim 14, further comprising forming an asynchronous write area with the asynchronous read area to convert one type of asynchronous data into another type of asynchronous data.
